(19) United States
(12) Patent Application Publication
(10) Pub. No.: US 2020/0370347 A1
(43) Pub. Date: Nov. 26, 2020

(54) LOCKING DEVICE FOR CONTROLLED LOCKING AND UNLOCKING OF AUTHORIZED OBJECTS

(71) Applicant: RAZVAN TROIE, BUCHAREST (RO)

(72) Inventor: RAZVAN TROIE, BUCHAREST (RO)

(21) Appl. No.: 15/733,158

(22) PCT Filed: Dec. 4, 2018
(86) PCT No.: PCT/RO2018/000021

§ 371 Date: May 30, 2020

(30) Foreign Application Priority Data
Dec. 7, 2017 (RO) A 2017 01055

(51) Int. Cl. E05C 3/24; E05B 47/06

(52) U.S. Cl. CPC E05C 3/24; E05B 47/0012; E05B 47/0607

(57) ABSTRACT

The invention relates to a locking device for the controlled locking and unlocking of authorized objects, meant to be used in particular within bicycle clamping and securing mechanisms of automatic systems, such as automatic bicycle rental stations. According to the invention, the device comprises a housing (1) consisting of a base plate (2) and a top plate (3), a rotary latch (5) which can move between an unlocked position and a locked position and an actuator controlled by an electronic control circuit, the device also comprising an anti-locking lever (8) which may rotate inside the locking device in the horizontal plane and which has a free end (8c) that can enter an anti-locking shoulder (5b) of the said rotary latch (5) for securing the locking device in the unlocked position, as well as an anti-unlocking lever (9) which may rotate inside the locking device in the horizontal plane and which has a free end (9c) that can enter an anti-unlocking shoulder (5d) of the said latch (5), for securing the locking device in the locked position, the said anti-locking lever (8) and anti-unlocking lever (9) being linked to each other by a traction spring (11) ensuring pulling of the two levers towards each other and maintaining them in this position, so that, in any moment, the end (8c or 9c) of only one of the said securing levers (8 or 9) is accommodated inside of the said blocking shoulder (5b or 5d) of the said rotary latch (5), while the respective free end (9c or 8c) of the other respective securing lever (9 or 8) is located outside the respective securing shoulder (5d or 5b) of the said latch (5), these positioning options making impossible the locking device to unlock or lock.

The invention relates to a latch or locking device controlled by an electronic controller, aimed at being used in bicycle securing mechanisms in automated bike rental systems but also possible to be used in other areas in which it is preferred to use such electromechanical latches for the purpose of controlling and mutually securing two bodies or assemblies authorized to be locked with respect to each other, one of which has a locking device according to the invention and the other having a counterpart specially provided for being accommodated and locked in the latching device.

In the field of general purpose locking mechanisms, various devices are known in which the active element consists of a rotary latch that can be rotated between two positions, unlocked and locked, either by manual actuation from outside for either of the two directions, i.e. moving from the unlocked position to the locked position and vice versa, or by manual actuation from outside only from the unlocked position to the locked position, unrestricted by any conditions, and being freed from the locked position to the unlocked position automatically, by an inner spring pushing directly or indirectly on the latch after an actuator has been energized by the latch controller so to release a locking part of the latch mechanism form its locked position.

Such a device is known from the U.S. Pat. No. 8,496,275 B2 as representing an electromechanical locking mechanism with a rotary latch that can be manually operated from outside by pushing the locking object body inside the latch mechanism until the rotary latch reaches the locked position which is obtained by the locking of one of its arms in a locking shoulder of a lever which is pushed by a torsion spring mounted on the rotation axis of that lever in the direction of coupling the locking shoulder with the end of an extended arm of the rotating latch. To release the latch from the locked position, an electromechanical actuator moves its longitudinal plunger along its axis until it pushes the free end of the locking lever and causes the rotary latch to automatically rotate in the sense of unlocking as an effect of an elastic force on the rotary latch caused by a second torsion spring being mounted on the latch shaft and pushing it all the way to its unlocking position. This device has a number of disadvantages with regards to an eventual use in a bicycle securing application in an automated bicycle rental station, of which some are as follows:
it does not restrict the insertion or operation of unauthorized objects in the rotating latch, thus allowing it to be pushed to its locked position by any lever or other physical object that can fit inside the latch;
once an object body has been locked inside the mechanism, an unlocking command sent by the controller to the actuator results in immediate and irreversible mechanical exit of the end of the locking arm of the rotary latch from the shoulder of the locking lever because of the elastic force that pushes the rotary latch towards the unlocked position, which means an irreversible movement of the rotary latch in a state that is either completely unlocked or at least in an intermediate unsecured position of the object body;
it does not detect unauthorized attempts for locking or unlocking of objects into or out of the locking mechanism so to transmit such alert signals to the locking device controller.

Another known locking device is that described in CA 2974118 A1, which has a rotary latch that can be pushed inwards for locking by an object body up to a position where a lateral arm of the rotary latch has rotated enough so that its free end enters behind the free end of a locking lever that is permanently tensioned by a spring towards the locking position, where for unlocking the locked object this latter should be slightly pushed still inwards as for locking, on a short distance so that the rotary latch rotates a bit more still inwards until its closes an electronic switch that sends a signal to the controller, which is understood as a user solicitation for unlocking and in turn the controller sends a command to the actuator to move its plunger so to free the locking lever which results in the automatic rotation of the latch towards the unlocked position. That causes the rotary latch to follow its path from the locked position to the unlocked position, which, in one embodiment of that invention, completely frees the retained object or, in a different embodiment, just moves that object in an unlocked position yet still retained only by a small retention force in the freed latch until the user manually pulls the object out completely. The solution presented in the patent application CA 2974118 A1 shows some disadvantages that are similar with those of the solution described by the document US 846275 B2, that is:
there is no protection against unauthorized use for locking of the latching device;
once the actuator receives a command for unlocking, the rotary latch is irreversibly pushed out from the locking position which results in eventually leaving the object body in an unlocked position;
there is no way to detect attempts of unauthorized use, except a partial case in one embodiment in which the switch that is acted upon by the rotary latch can send electrical signals to the locking device controller in order to alert eventual unauthorized attempt unlocking and only if the user pushes the locked object as if he wants to get it unlocked normally through a controller command and if his action is not doubled by a second means of confirmation for authorizing the unlocking of the object body. However, even in this case there is no way to sense and alert eventual unauthorized attempt of just pulling of the object out from the locking device. And there is no way to sense attempts of unauthorized locking of objects.

Unlike known systems, the locking device according to the present invention introduces several novel elements especially aimed at a stricter control of operation in applications such as that of automatic bike rental stations and also aimed at a simpler and cheaper production technology applicable even in the condition of a small scale production.

Throughout the description of the present invention, authorized object and object logically authorized for locking shall have one of the following meanings:
a certain generic category of special destination objects aimed to be used in conjunction with a locking device as that described by the present invention, for instance but with no limitations to this application type only, a special locking ring mounted on the body of a bicycle in an application of automatic bike rental stations;
in some particular use cases pertaining to objects from the generic category aforementioned, in the sense that only exactly one or only certain objects out of the generic objects aimed at being used together with a locking device according to the present invention can be permitted for actual use in a given locking device, that is only those objects that have certain identifiers or other unique means of identification and, optionally, of authentication, within a logical system that can control the locking device after comparing with an existing reservation for those identifiers. In the case of an automatic bike rental system, this feature can be useful to assure a certain docking port that is equipped with such a locking device in order to allow the locking of a certain bike having a unique identifier for which there is a docking reservation registered with the application system, so that the respective user has the certitude of finding a free docking port available in a destination bike station.

According to one aspect, the present invention solves the problem of controlling the access for locking an object inside the locking device, in that it allows the movement of the rotary latch from the unlocked position to the locked position only for objects that are authorized for locking by the logic of the locking device controller. According to a second aspect, the present invention also solves the need of re-assuring the object in a locked position if it has not been pulled out from the locking device in a certain timeout interval after an unlock command as well as the need of re-assuring the rotary latch of the locking device in the unlocked position if no authorized object for locking has been actually locked by a user in a certain timeout interval after a lock command. And according to a third aspect, the present invention also solves the need for detecting and signaling to the electronic controller of any unauthorized use or brute force attack on the locking device, either in the unlocked or in the locked positions of the locking device and for any sense of the exterior force that attempts that unauthorized use.

The locking device according to the present invention is characterized in that it consists form a rotary latch that has the possibility to be rotated between two firmly stable positions, namely “unlocked” and, respectively, “locked”, positions in which the rotary latch automatically remains secured in a blocked state after its movement to that respective position has ended, such that, the moving of the rotary latch from the “unlocked” position to the “locked” position or vice versa determines one arm that is extended from the rotary latch to act as a cam upon a cam follower that is elastically tensed by compression springs inside the locking device, obtaining a maximum of the elastic tensioning force at the mid-way of the cam-arm of the rotary latch between its positions corresponding to the “unlocked” position and the “locked” position of the rotary latch, so that the respective cam follower tends to push the rotary latch either to the “unlocked” position or to the “locked” position, depending on the direction of the resultant force of the manual acting force from outside by an user on the object body and the reaction force between the cam-arm and the cam follower that is pushed inside the locking device. In both positions, “unlocked” and “locked”, the rotary latch is automatically and immediately secured in a blocked state by one of two blocking levers that, immediately after the end of the latch moving to that respective position, enters with one end in a special corresponding cut that is made in the body of the rotary latch. Furthermore, the locking device according to the present invention is also characterized by that it comprises two limit switches that are placed each at one of the two ends of the stroke of the rotary latch corresponding to the positions “unlocked” and “locked”, which have the role to detect and signalize to the locking device controller the confirmation of the position “unlocked” or “locked” where the rotary latch is upon case, and also have the role to instantly detect eventual attempts of unauthorized pushing or pulling of the rotary latch out of its “unlocked” or “locked” positions, as a result of opening and closing of each of the two limit switches due to the possibility to execute a very short movement of the rotary latch within the limits of certain small mechanical gaps especially designed for this scope in the mechanism of the locking device assembly, which does not allow however the unblocking or the moving of the rotary latch out of the secured positions “unlocked”, respectively “locked”, where it is on that moment.

The locking device according to the present invention has the following advantages:
it allows only authorized objects to cause the unblocking of the rotary latch from the “unlocked” position so that it can be pushed towards the “locked” position, so that only those authorized objects can be locked inside the locking device, which therefore avoids the locking of unauthorized objects or just pushing the rotary latch inwards, towards the “locked” position;
it securely retains the rotary latch there where it is, in the “unlocked” or in the “locked” position even if the controller had commanded the unlocking of the latch from that respective position, either until a user firmly pulls or pushes the object that has to be unlocked or locked, or until a certain operation timeout expires or a certain administrative command is issued and, as result, the locking device controller cancels the permission to unblock the moving of the rotary latch out of that respective position;
through its particular conformation, the locking device ensures special features for the detection and signaling to the controller about eventual attempts of pulling the locked object out of the “locked” position and about eventual attempts of taking the rotary latch out of the “unlocked” position and pushing it towards the “locked” position with an unauthorized object;
due to the simple geometry of the main parts of the locking device, the execution of those components can be made much simpler than in the case of other known locking devices, exclusively through machining techniques such as several thicknesses metal sheet cutting and bending, which avoids the need of special molds and other tools that in other cases could be needed for operations like casting, deforming or other technologies, which in the end has the benefit of a more convenient production price even in case of small batches of products;
also, due to the geometry of some of the parts, the assembling of the locking device can be made in a small number of operations and with very few fasteners, which leads to a reduction of the time and cost of assembling.

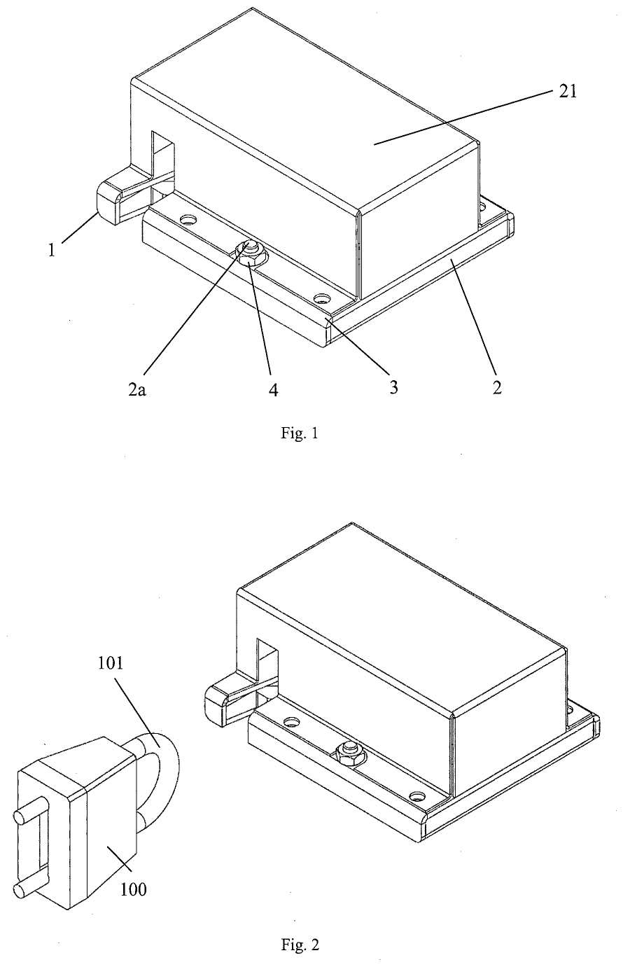

The following detailed description of the invention is accompanied by the drawings presented in the FIGS. 1 to 31, which represent:

FIG. 1 represents a perspective view of the locking device according to the present invention, in its complete assembly;

FIG. 2 represents a perspective view of the locking device according to the present invention together with a locking ring that can be attached to an object aimed at being locked in this locking device, object or locking ring that are not part of the present invention;

FIG. 3 represents a perspective view of the locking device according to the present invention with the upper lid removed;

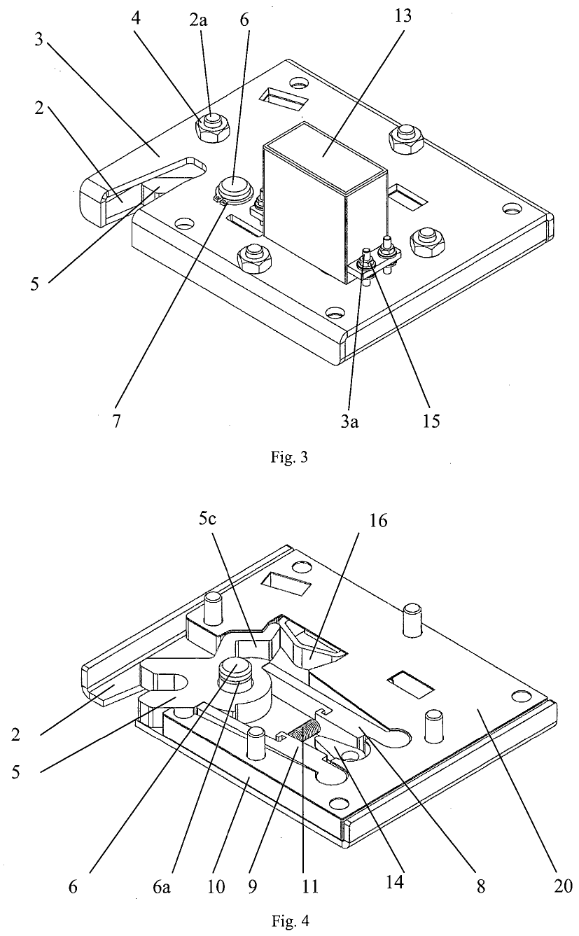

FIG. 4 represents a perspective view of the locking device according to the present invention with the upper lid and the top plate removed;

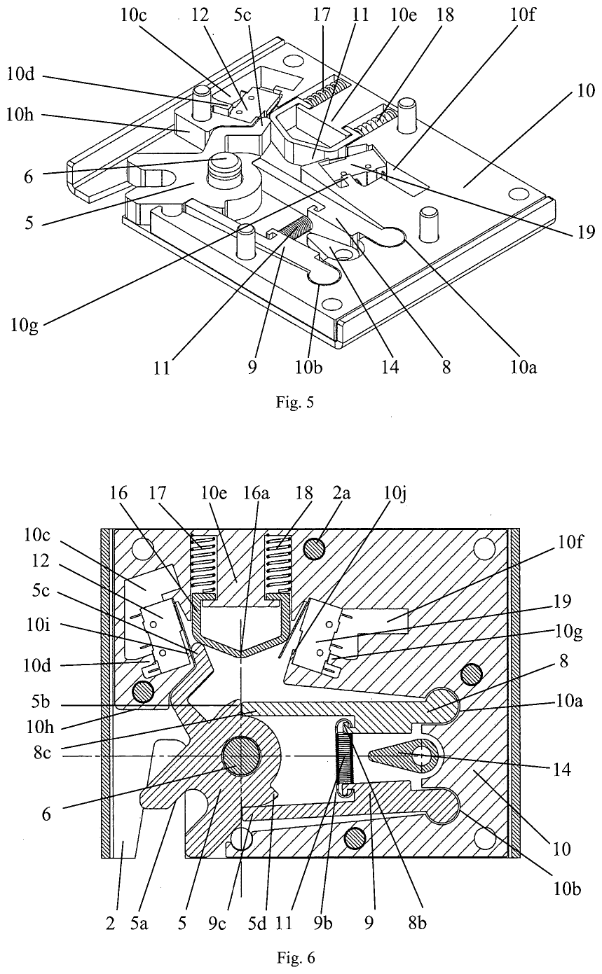

FIG. 5 represents a perspective view of the subassembly comprising the parts from under the thin spacer of the locking device, in a first embodiment;

FIG. 6 depicts a horizontal plane section of the subassembly comprising the parts from under the thin spacer of the locking device, in a first embodiment, in the “secured in the unlocked position” state;

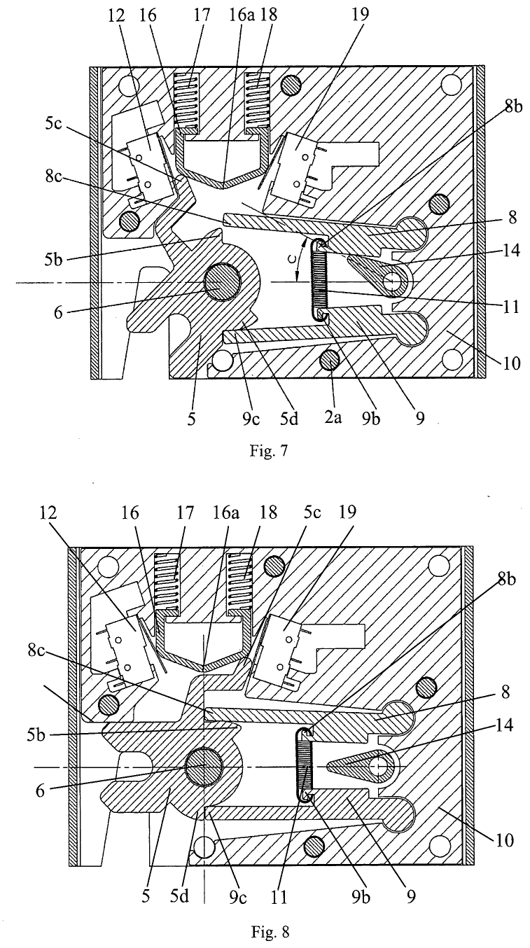

FIG. 7 depicts a horizontal plane section of the subassembly comprising the parts from under the thin spacer of the locking device, in a first embodiment, in the “unsecured in the unlocked position” state;

FIG. 8 depicts a horizontal plane section of the subassembly comprising the parts from under the thin spacer of the locking device, in a first embodiment, in the “secured in the locked position” state;

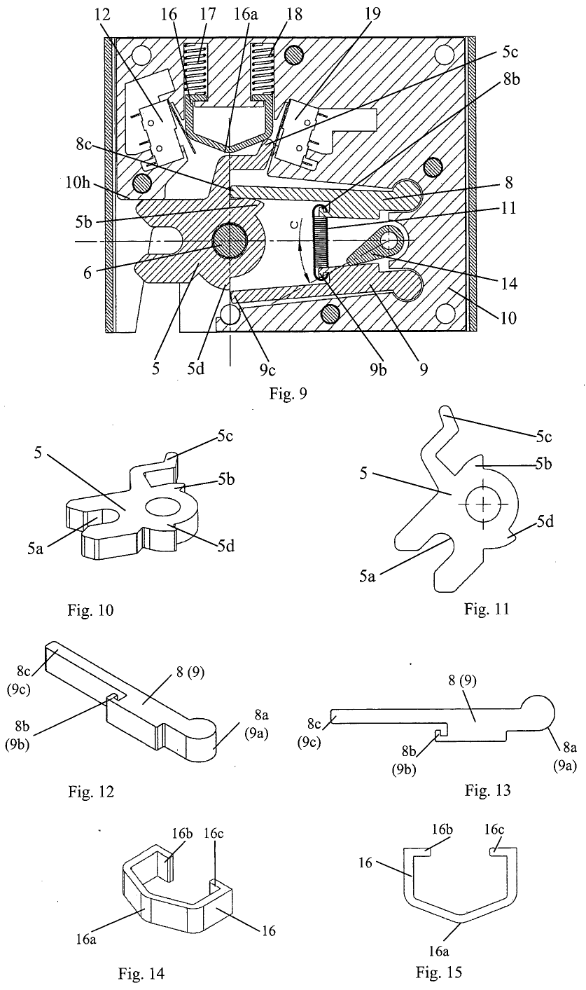

FIG. 9 depicts a horizontal plane section of the subassembly comprising the parts from under the thin spacer of the locking device, in a first embodiment, in the “unsecured in the locked position” state;

FIG. 10 shows a perspective view of the rotary latch, according to the first embodiment of the invention;

FIG. 11 shows a top view of the rotary latch, according to the first embodiment of the invention;

FIG. 12 shows a perspective view of one of the two identical blocking levers;

FIG. 13 shows a top view of one of the two identical blocking levers;

FIG. 14 shows a perspective view of the cam follower pushing on the rotary latch;

FIG. 15 shows a top view of the cam follower pushing on the rotary latch;

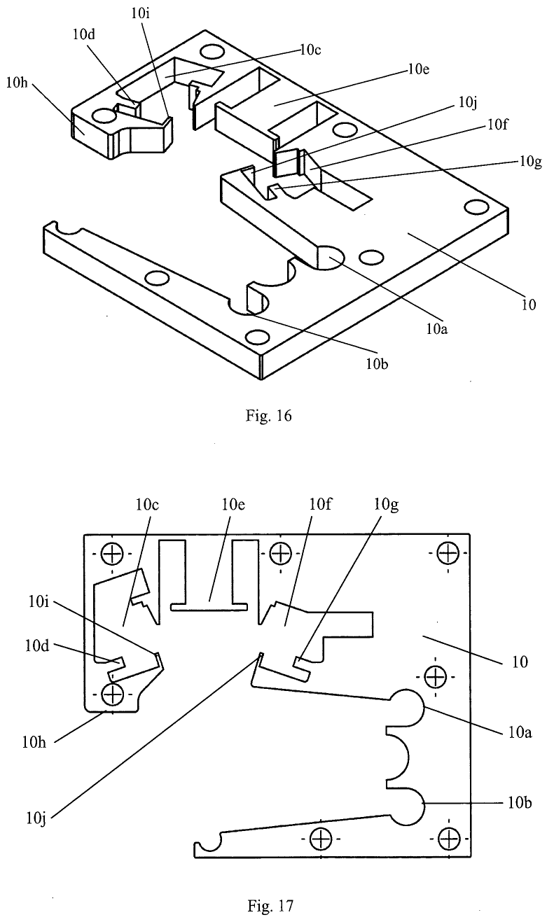

FIG. 16 represents a perspective view of the main holder, according to the first embodiment of the invention;

FIG. 17 represents a top view of the main holder, according to the first embodiment of the invention;

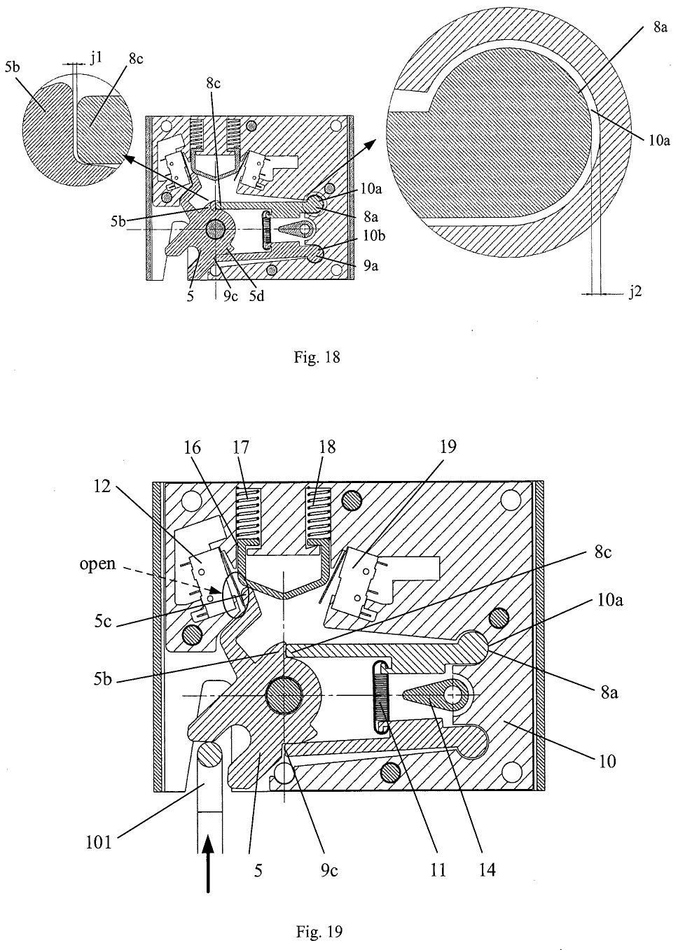

FIG. 18 represents a horizontal plane section of the subassembly comprising the parts from under the thin spacer of the locking device, in a first embodiment, in the “secured in the unlocked position” state, with two detail areas showing two mechanical gaps specially designed for the functional role of detecting unauthorized attempts of locking;

FIG. 19 represents a horizontal plane section of the subassembly comprising the parts from under the thin spacer of the locking device, in a first embodiment, in the “secured in the unlocked position” state, showing the mechanical effect of the unauthorized pushing from outside on the rotary latch in an attempt of moving it to the “locked” position;

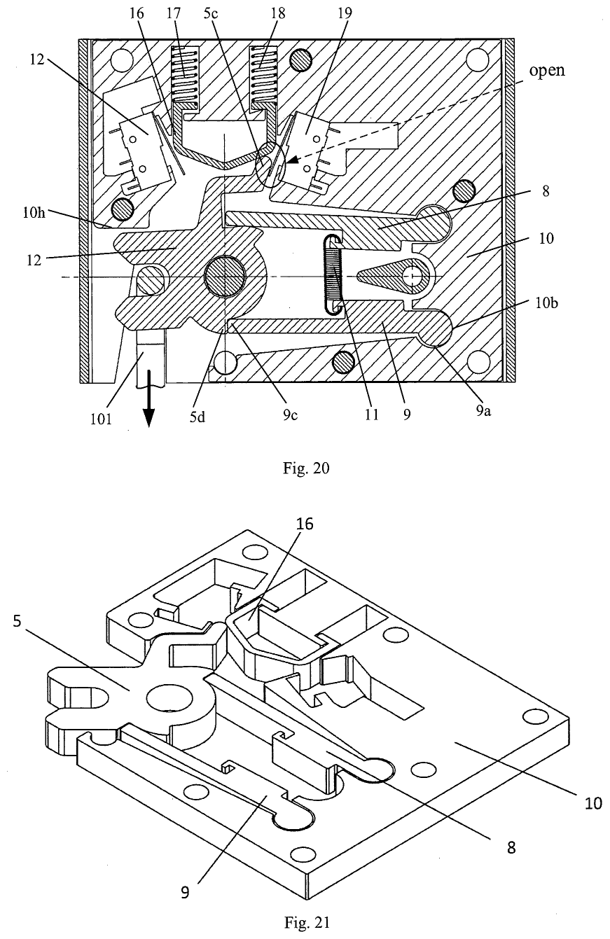

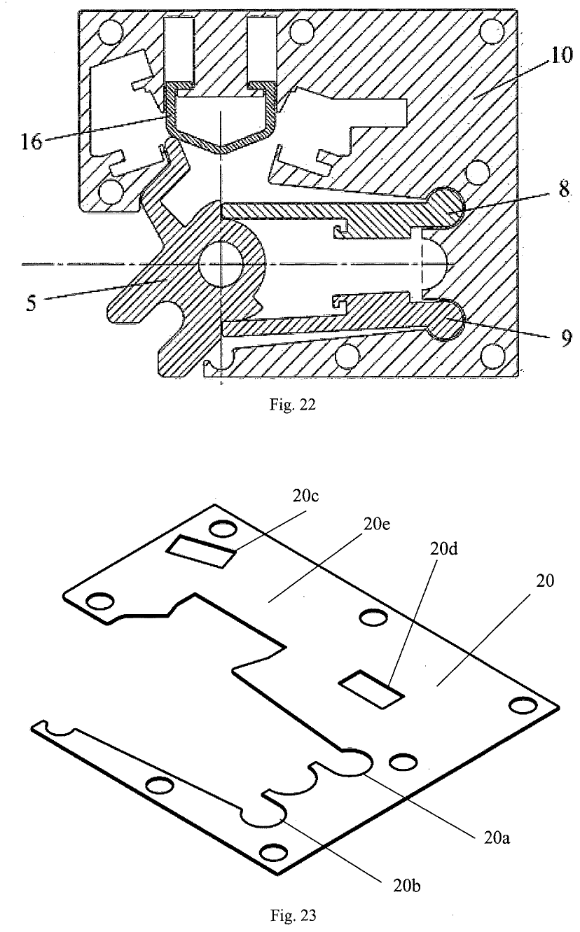

FIG. 20 represents a horizontal plane section of the subassembly comprising the parts from under the top spacer of the locking device, in a first embodiment, in the “secured in the locked position” state, showing the mechanical effect of the unauthorized pulling from outside on the locked object in an attempt to unlock it;

FIG. 21 represents a perspective view only of the internal parts from between the base and the top plates, according to the first embodiment of the invention, showing the equal thickness of those parts;

FIG. 22 is a top view of the internal parts having equal thickness from between the base plate and the top plate, according to the first embodiment of the invention;

FIG. 23 shows a perspective view of the thin spacer, according to the first embodiment of the locking device;

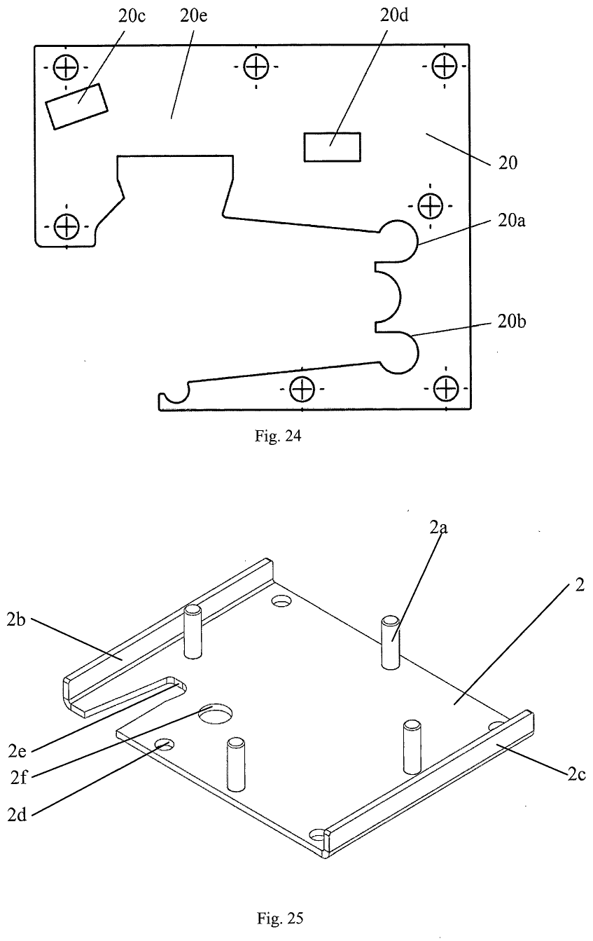

FIG. 24 shows a top view of the thin spacer, according to the first embodiment of the locking device;

FIG. 25 shows a perspective view of the base plate, according to the first embodiment of the locking device;

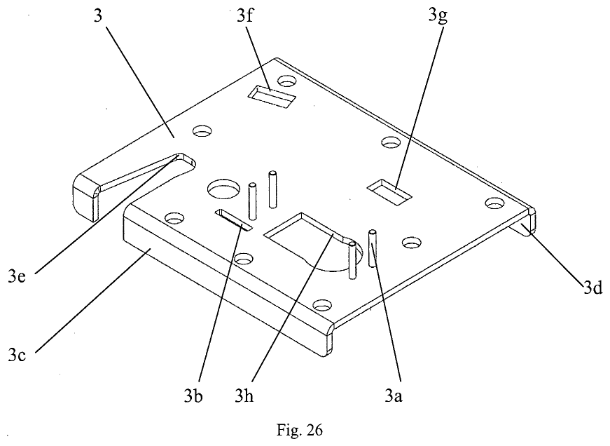

FIG. 26 shows a top view of the top plate, according to the first embodiment of the locking device;

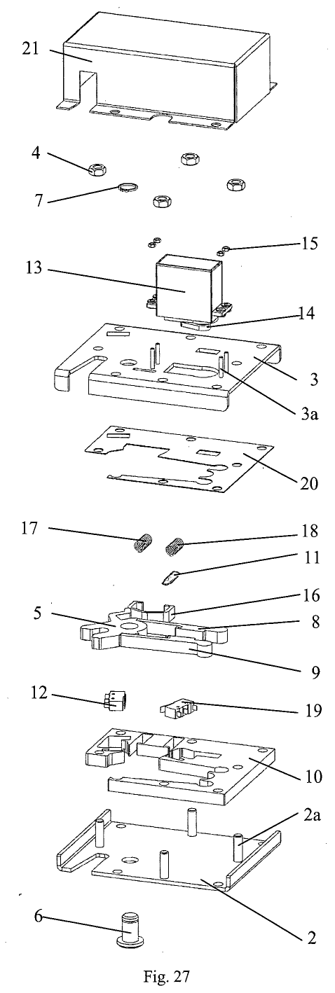

FIG. 27 is an exploded view of the locking device components, in its first embodiment;

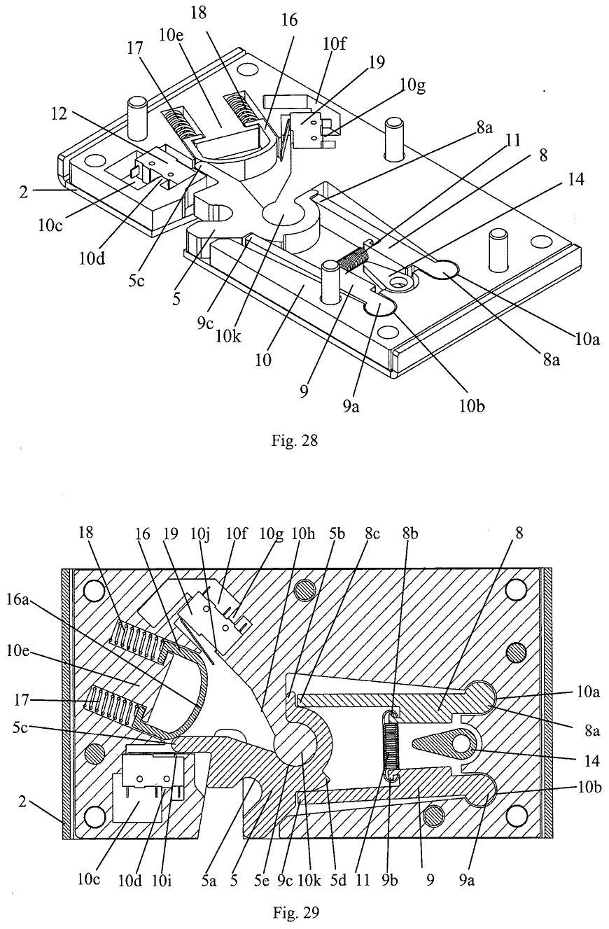

FIG. 28 is a perspective view of the locking device with the top plate and the thin spacer removed, in a second embodiment of the invention;

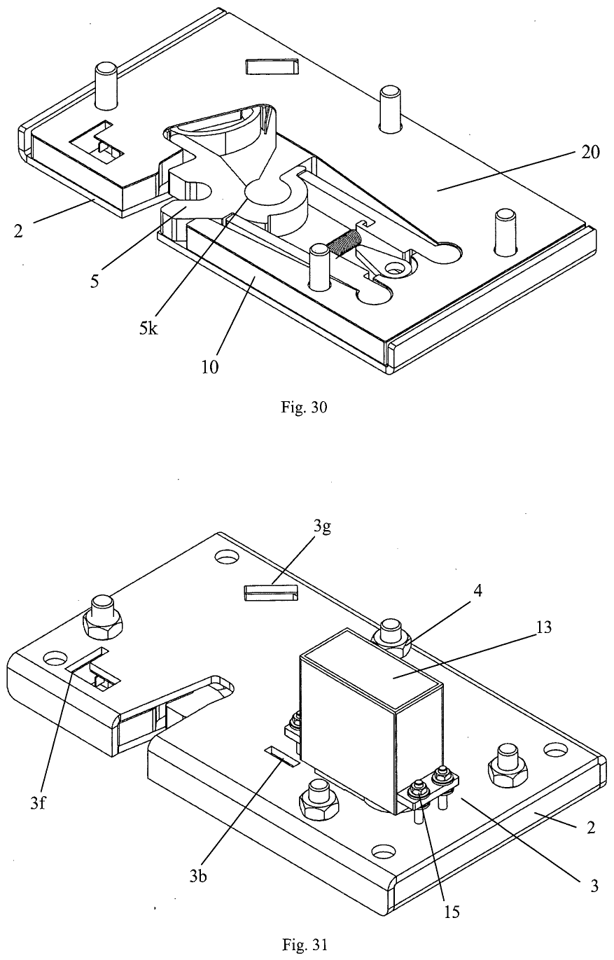

FIG. 29 shows a horizontal plane section of the subassembly comprising the parts from under the thin spacer of the locking device, in the second embodiment, in the “secured in the unlocked position” state;

FIG. 30 is a perspective view of the locking device with the top plate removed, in the second embodiment of the invention;

FIG. 31 represents a perspective view of the subassembly of the parts from under the upper lid of the second embodiment of the locking device.

The locking element consists from a rotary latch that is able to rotate inside the housing of the locking device between two positions, “unlocked” and “locked”, in each of which the rotary latch is secured against exiting from that respective position by the means of one of two blocking levers that are tied to one another by a traction spring, where one of the two blocking levers is aimed at preventing the rotary latch from unauthorized movements out of the “unlocked” position and the other blocking lever is aimed at preventing the rotary latch from any unauthorized movement out of the “locked” position, the two blocking levers being actuated by an eccentric rotor that in turn is actuated by a rotary stepper motor with the rotation axis perpendicular on the rotation plane of the rotary latch. The control of the positioning of the rotary latch is further completed by the action of a cam follower that is tensed by two compression springs inside the main holder part mounted inside the locking device, so that the cam follower pushes on the end of a cam-arm extended from the rotary latch, which causes the rotary latch to be permanently biased towards the closest of the positions “unlocked” or “locked”, where the reaching of each of these two positions is confirmed by engaging a corresponding limit switch which is connected to the electronic controller of the locking device.

According to one aspect of the invention, the locking device is characterized by that it has four distinct fixed mechanical states:

1. the locking device is, with no time limitation, in the idle “secured in the unlocked position” state, where it is neither permitted nor possible to push the rotary latch towards the interior of the locking device;

2. the locking device is, for a maximum time interval (also called “lock timeout”), in the “unsecured in the unlocked position” state, in which it is allowed and possible to push the rotary latch towards the interior of the locking device, towards the “locked” position;

3. the locking device is, with no time limitation, in the idle “secured in the locked position” state, where it is neither permitted nor possible to pull the rotary latch towards the “unlocked” position;

4. the locking device is, for a maximum time interval (also called “unlock timeout”), in the “unsecured in the locked position” state, in which it is allowed and possible to pull the rotary latch towards the “unlocked” position,

and additional to these four fixed mechanical states there are all transitory states in which the locking device can be during the moving of the rotary latch towards one of the positions “locked” or “unlocked” as a result of an external force manually exerted upon the object that is to be locked or unlocked and once the rotary latch reaches that final position, “locked” or “unlocked”, the locking device automatically enters the “secured in the locked position” state or, respectively, “secured in the unlocked position”.

According to another aspect of the present invention, the locking device is characterized by that it is designed and build in such a way to minimize the risks of non-compliant use or even theft of the locked object, grace to the way the locking device is controlled and to the design of the two idle states “secured in the unlocked position” and, respectively, “secured in the locked position”.

According to yet another aspect of the invention, the locking device is characterized by that it is designed and build in such a way so that it provides the user with a firm mechanical feed-back on the insertion and moving of the object to be locked inside the locking device up to the position “locked” and also on the pulling of the locked object out of the “locked” position up to the “unlocked” position, after the rotary latch transitorily passes through a maximum tension point at its mid-way between the two positions, “unlocked’ and “locked”, due to the mechanism formed by the cam-arm of the rotary latch together with the cam follower, in order to amplify the dynamics of the move of the rotary latch towards each of the two end positions.

According to yet another aspect of the invention, the locking device is characterized by a special design of its component parts providing some mechanical gaps inside their assembly, which can cause the closing or opening of two limit switches related to the “unlocked” and “locked” positions and, as a result, detecting and transmitting of electronic signals to the controller about potential non-compliant use of the locking device, such as unauthorized attempts of locking or unlocking of objects or even forcing of the locking device in an attempt of theft or in an attempt of breaking it down.

According to yet another aspect of the invention, the locking device is characterized by the fact that it is actuated between the secured and the unsecured states of the rotary latch, in both positions, “unlocked” and “locked”, by the means of a rotor that is rotated by a step-by-step motor and, in the case of a power failure, the rotor can be retired back from a position corresponding to an unsecured state of the rotary latch in a safe median position, by the spring that ties the two blocking levers one to another.

The locking device comprises a housing 1 that comprises a base plate 2 on which there are four threaded rods 2a steadily fixed and a top plate 3 that is parallel with the base plate 2, where the two plates 2 and 3 are assembled together with four nuts 4 that are secured on the threaded rods 2a. A rotary latch 5 is mounted between the base plate 2 and the top plate 3, where it has the possibility to rotate around an axis that is perpendicular to the plates 2 and 3.

In a first embodiment of the invention, in respect to FIG. 1-27, the rotation joint of the rotary latch 5 consists from a cylindrical bolt 6 which has at one end a flat cap with a diameter that is greater than that of the body of the bolt 6 and at the other end has a cylindrical recess 6a on which is mounted a safety ring 7 that secures the bolt 6 in the assembly formed by the base plate 2, the rotary latch 5 and the top plate 3.

The rotary latch 5 can rotate between two fixed end positions, “unlocked” and “locked”, only as a result of an external action upon an object body 100, which is not part of the present invention and which has a locking ring 101 that is not part of the present invention also, so that the locking ring 101 is pushed inside a U-shaped recess 5a of the rotary latch 5 for the locking operation, as shown in FIG. 6. In order to be permitted for locking, the object body 100 should be detected, identified and authorized for locking by the controller of the locking device, which can be done through various means that are not in the scope of the present invention, for instance by an RFID tag attached to the object body 100 that can be read by an RFID reader mounted in the proximity of the locking device, so that in case the locking device controller determines that the identifier of that object body 100 is recognized and permitted for locking, then the controller sends a command to the locking device that passes it from the “secured in the unlocked position” state to the “unsecured in the locked position” state.

When the locking device is in the “secured in the unlocked position” state, as in FIG. 6, the rotary latch 5 is secured to remain in its firm position corresponding to this state by an anti-locking lever 8. When the locking device is in the “secured in the locked position” state, as in FIG. 8, the rotary latch 5 is secured to remain in its firm position corresponding to this latter state by an anti-unlocking lever 9.

The anti-locking lever 8 and the anti-unlocking lever 9 are made of parts that can be identical to each other and that are mounted inside the locking device symmetrically one from another in respect to a vertical plane that contains the rotation axis of the rotary latch 5, as shown in FIGS. 4-9, and the two levers 8 and 9 can rotate inside a main holder 10, each lever around a rotation joint that is formed by a circular protrusion 8a and, respectively 9a of each lever 8 and, respectively, 9, and a corresponding circular cut 10a, respectively 10b, shaped in the body of the main holder 10. The two levers 8 and 9 are tied to each other by a traction spring 11 having its ends hooked on two hooks, 8b and 9b, shaped one in the anti-locking lever 8, and the other one in the anti-unlocking lever 9.

The placement of the rotary latch 5 in the “unlocked” position is detected by the controller of the locking device through the closing of a limit switch 12 that is mounted in a first special pocket 10c shaped inside the main holder 10, as represented in FIG. 5. Only the “Normal open” circuit of the limit switch 12 is used in the embodiments of this invention, that is only the first two electrical pins of the limit switch 12 are used, counted from the fixed end of the limit plate. The third electrical pin, “Normal closed” is not used in this invention. Inside the first special pocket 10c of the main holder 10 there is a small first pin 10d that firmly holds the limit switch 12 inside the first special pocket 10c and also ensures a physical separation of the third electrical pin of the limit switch 12 from the other pins. The limit switch 12 is also maintained in a fixed position by a first small shoulder 10i that is placed between the switch body and the swinging blade of the switch 12 and which has a small thickness, maximum 2 mm, so that it does not prevent the normal operation of the swinging blade of the switch 12.

The free end 8c of the anti-locking lever, which is opposed to the circular protrusion 8a that is part of the rotation joint of the lever 8, is designed such that it is placed inside an anti-locking shoulder 5b that is shaped in the rotary latch 5, when the rotary latch 5 is blocked in the “unlocked” position. This position of the anti-locking lever 8 restricts any possibility of the rotary latch 5 to rotate towards the “locked” position.

In case of a manual action from outside in the sense of locking an object 100 inside the locking device, the process flow is as follows: the electronic controller, which is not represented in the accompanying figures, detects the proximity of the object 100 that is authorized for locking and sends an electronic command to an actuator 13 to rotate its shaft and an attached eccentric rotor 14 so to move the locking device form the “secured in the unlocked position” state into the “unsecured in the unlocked position” state. The actuator 13 can be a stepper motor that is fastened on the top plate 3 by four screws 3a and four corresponding nuts 15. The shaft of the actuator 13 can execute a fraction of a rotation and leads the eccentric rotor 14 attached to the end of the actuator shaft on an angular stroke c in counter-trigonometric sense, as shown in FIG. 7, so that the rotor 14 pushes the anti-locking lever 8 in the sense of pulling its free end 8c out of the anti-locking shoulder 5b of the rotary latch 5, which actually means moving the locking device from the “secured in the unlocked position” state into the “unsecured in the unlocked position” state. The rotor 14 shall remain in this latter position and it shall also maintain the anti-locking lever 8 in this position until one of the following events happens:
i. the locking ring 101 of the object 100 authorized for locking is introduced inside the U-shaped recess 5a of the rotary latch 5 and then the rotary latch 5 is further pushed so that it leaves the “unlocked” position and moves to the “locked” position where the locking device automatically enters the “secured in the locked position” state as shown in FIG. 8, with the condition that this operation is completed in an interval of time that does not exceeds a certain timeout for locking parameter that is set up in a software application that governs the electronic controller of the locking device, where this timeout is recommended to be in the range of 10 s-30 s so that there is enough time for the user to operate the locking of the object body 100 inside the locking device, or
ii. that timeout allowed for the locking operation expires without the rotary latch 5 being moved from its “unlocked” position, so that the electronic controller commands the actuator 13 to move its shaft and the attached rotor 14 back to its median position on the horizontal axis, at mid distance between the levers 8 and 9, which determines that the spring 11 pulls the anti-locking lever 8 back until it is placed with its free end inside the anti-locking shoulder 5b of the rotary latch 5, which re-secures the locking device in the initial “secured in the unlocked position” state, as shown in FIG. 6, or
iii. at any moment inside the interval of the timeout for locking, the electronic controller of the locking device sends the actuator 13 an administrative command to abort the position corresponding to the “unsecured in the unlocked position” state so that the rotor 14 gets back on the horizontal median axis between the levers 8 and 9 and the spring 11 pulls the anti-locking lever 8 back until it is placed with its free end 8c inside the anti-locking shoulder 5b of the rotary latch 5, which re-secures the locking device in the “secured in the unlocked position” state as shown in FIG. 6.

In the case of the first event i. just mentioned previously, where an authorized object 100 is pushed inside the recess 5a of the rotary latch 5 within the timeout for locking interval when the locking device is in the “unsecured in the unlocked position” state having its anti-locking lever 8 pushed by the rotor 14 with its free end 8c outside the anti-locking shoulder 5b of the rotary latch 5, this latter rotates around the bolt 6 from the “unlocked” position towards the “locked” position and together with it, a cam-arm 5c elongated from the body of the rotary latch 5 acts with its end as a cam on a cam follower 16 that can slide around a guiding rod 10e that is shaped in the main holder 10 so that the cam follower 16 compresses two compression strings, 17 and 18. The cam-arm 5c has also the role to close the limit switch 12 that confirms the placement of the rotary latch 5 in the “unlocked” position and also to close a limit switch 19 that confirms the placement of the rotary latch 5 in the “locked” position. The configuration with the pair of the two compression strings 17 and 18 on each side of the special guide 10e is recommended for a better stability of the cam follower 16 on its symmetry axis during its movement along the special guiding rod 10e, taking into consideration the relatively high width of the cam follower 16 compared to the length of its stroke.

While the rotary latch 5 rotates from the “unlocked” position to the “locked” position, its anti-unlocking shoulder 5d rotates above the upper side of the anti-unlocking lever 9, in the vicinity of the free end 9c of this lever 9. As soon as the rotary latch 5 reaches the “locked” position as result of the external pushing force exerted on the object body 100 and also as result of the reaction force between the cam follower 16 and the cam-arm 5c, the free end 9c of the anti-unlocking lever 9 is automatically pulled by the spring 11 towards the horizontal axis between the center of rotary latch 5 and the center of the rotor 14, and it reaches the stable position inside the anti-unlocking shoulder 5d of the rotary latch 5, which represents the passing of the locking device from the “unsecured in the unlocked position” state into the “secured in the locked position” state, as shown in FIG. 8. Once arrived in this position, the “locked” position of the rotary latch 5 is detected by the closing of the limit switch 19, which transmits this signal to the electronic controller of the locking device. Only the “Normal open” circuit of the limit switch 19 is used in the embodiments of this invention, that is, only the first two electrical pins of the limit switch 19 are used, counted from the fixed end of the swinging blade. The third electrical pin, “Normal closed” is not used in this invention. The limit switch 19 is mounted inside a hole 10f of the main holder 10, where a there is a second small pin 10g that firmly holds the limit switch 19 inside the hole 10f and also ensures a physical separation of the third electrical pin of the limit switch 19 from its other electrical pins. The limit switch 19 is also maintained in a fixed position by a small shoulder 10j that is placed between the switch body and the swinging blade of the switch 19 and which has a small thickness, maximum 2 mm, so that it does not prevent the normal operation of the swinging blade of the switch 19.

The closing of the limit switch 19 is transmitted to the controller, which in response commands the actuator 13 to retire the rotor 14 from the position corresponding to the “unsecured in the unlocked position” state and move it to its idle median position, according to FIG. 8. Retiring the rotor 14 has the direct effect of freeing the anti-locking lever 8 so that is pulled back by the spring 11 in a position where the free end 8c touches the external side of the anti-locking shoulder 5b, which had got under the lower side of the anti-locking lever 8 during the rotation of the rotary latch 5 towards the “locked” position.

The profile of the cam follower 16 has a geometry designed so that it exerts a variable reaction force on the cam-arm 5c of the rotary latch 5 during its rotation from the “unlocked” position towards the “locked” position or in the opposite sense. As such, the reaction force on the cam-arm 5c of the rotary latch 5 during its rotation from the “unlocked” position to the “locked” position rises from a minimum but greater than zero value corresponding to the position where the free end of the cam-arm 5c is near the left side corner of the cam follower 16 which corresponds to the “locked” position of the rotary latch 5, up to a maximum value near the tip 16a of the cam follower 16 and then the force decreases down to a minimum but greater than zero value where the end of the cam-arm 5c reaches the right side corner of the cam follower 16, which corresponds to the “locked” position of the rotary latch 5.

In respect to the operation of unlocking an object body 100 that is locked inside the locking device, the process flow is as follows: the electronic controller receives a command to unlock the locking device from the system in which the locking device is installed, and as response the controller commands the actuator 13 to rotate its shaft and the attached rotor 14 so to move the locking device form the “secured in the locked position” state into the “unsecured in the locked position” state. The shaft of the actuator 13 executes a fraction of a rotation and leads the eccentric rotor 14 on an angular stroke c in trigonometric sense so that the rotor 14 pushes the anti-unlocking lever 9 in the sense of pulling its free end 9c out of the anti-unlocking shoulder 5d of the rotary latch 5, which actually means moving the locking device from the “secured in the locked position” state into the “unsecured in the locked position” state. The rotor 14 shall remain in this latter position and it shall also maintain the anti-locking lever 8 in this position until one of the following events happens:
iv. the object 100 is pulled by the user out of the locking device, which causes the rotation of the rotary latch 5 from the “locked” position up to the “unlocked” position where the locking device automatically enters the “secured in the unlocked position” state, with the condition that this operation is completed in an interval of time that does not exceeds a certain timeout for unlocking parameter that is set up in the software application that governs the electronic controller of the locking device, where this timeout is recommended to be in the range of 10 s-30 s so that there is enough time for the user to operate the unlocking of the object body 100, or
v. that timeout allowed for the unlocking operation expires without the rotary latch 5 being moved from its “locked” position, so that the electronic controller commands the actuator 13 to move its shaft and the attached rotor 14 back to its median position on the horizontal axis, at mid distance between the levers 8 and 9, which determines that the spring 11 pulls the anti-unlocking lever 9 back until it is placed with its free end inside the anti-unlocking shoulder 5d of the rotary latch 5, which re-secures the locking device in the “secured in the locked position” state, or
vi. at any moment inside the interval of the timeout for locking, the electronic controller of the locking device sends the actuator 13 an administrative command to abort the position corresponding to the “unsecured in the locked position” state so that the rotor 14 returns on the horizontal median axis between the levers 8 and 9 and the spring 11 pulls the anti-unlocking lever 9 back until this latter is placed with its free end 9c inside the anti-unlocking shoulder 5d of the rotary latch 5, which re-secures the locking device in the “secured in the locked position” state.

In the case of the first event iv. just mentioned above, where the object 100 is pulled out of the locking device within the timeout for unlocking interval when the locking device is in the “unsecured in the locked position” state having its anti-unlocking lever 9 pushed by the rotor 14 with its free end 9c outside the anti-unlocking shoulder 5d of the rotary latch 5, this latter rotates around the bolt 6 from the “locked” position towards the “unlocked” position and together with it, the cam-arm 5c elongated from the body of the rotary latch 5 acts with its end as a cam on the cam follower 16 similarly but in opposite sense compared to the movement of the rotary latch 5 from the “unlocked” position to the “locked” position.

While the rotary latch 5 rotates from the “locked” position to the “unlocked” position, its anti-locking shoulder 5b rotates under the lower side of the anti-locking lever 8, in the proximity of the free end 8c of this lever 8. As soon as the rotary latch 5 reaches the “unlocked” position as result of the external pulling force exerted on the object body 100 and also as result of the reaction force between the cam follower 16 and the cam-arm 5c, the free end 8c of the anti-locking lever 8 is automatically pulled by the spring 11 towards the horizontal axis between the center of the rotary latch 5 and the center of the rotor 14, and it reaches the stable position inside the anti-locking shoulder 5b of the rotary latch 5, which represents the passing of the locking device from the “unsecured in the locked position” state into the “secured in the unlocked position” state, as shown in FIG. 6. Once arrived in this position, the “unlocked” position of the rotary latch 5 is detected by the closing of the limit switch 12, which transmits this signal to the electronic controller of the locking device. In response, the controller commands the actuator 13 to retire the rotor 14 from the position corresponding to the “unsecured in the locked position” state into its idle median position on the horizontal axis, as shown in FIG. 6, which determines the anti-unlocking lever 9 to move under the action of the spring 11 until the free end 9c leans on the external side of the anti-unlocking shoulder 5d of the rotary latch 5.

Similarly to the dynamics of the rotary latch 5 rotating from the “unlocked” position to the “locked” position, in case of the rotary latch 5 moving from the “locked” position to the “unlocked” position the cam follower 16 exerts a reaction force on the cam-arm 5c of the rotary latch 5, which rises from a minimum but greater than zero value in the position where the free end of the cam-arm 5c is near the right side corner of the cam follower 16 which corresponds to the “locked” position of the rotary latch 5, up to a maximum value near the tip 16a of the cam follower 16 and then the force decreases down to a minimum but greater than zero value where the end of the cam-arm 5c reaches the left side corner of the cam follower 16, which corresponds to the “unlocked” position of the rotary latch 5.

The functional roles of the cam-arm 5c and the cam follower 16 in the case of the rotary latch 5 rotating between the “unlocked” and “locked” positions are as follows:

1. A tendency of auto-positioning the rotary latch 5 along its stroke c either in the “unlocked” or in the “locked” position, so that in case of eventual cancellation of any external force upon the object 100, the rotary latch 5 moves to the nearest end position and once arrived in that respective position indirectly causes putting the locking device either in the “secured in the unlocked position” state or in the “secured in the locked position” state, accordingly. As such, the following cases can arise:
a. if the user desired to lock an authorized object 100 inside the locking device and if, after the locking operation was authorized by the system in which the locking device is installed, the user pushed the object 100 so that the rotary latch 5 only moved to an intermediary position anywhere between the “unlocked” position and the mid-way position between the “unlocked” and the “locked” positions, and then the user ceased exerting any force on the object 100, then the system of the cam-arm 5c and the cam follower 16 causes the rotary latch 5 to move back to the “unlocked” position;
b. if the user desired to lock an authorized object 100 inside the locking device and if, after the locking operation was authorized by the system where the locking device is installed, the user pushed the object 100 so that the rotary latch 5 moved beyond the mid-way position between the “unlocked” and the “locked” positions, and then the user ceased exerting any force on the object 100, then the system of the cam-arm 5c and the cam follower 16 causes the rotary latch 5 to continue its rotation until it reaches the “locked” position;
c. if the user desired to unlock an object 100 from the locking device and if, after the unlocking command was issued by the controller the user pulled the object 100 so that the rotary latch 5 moved less than half-way between the “locked” and the “unlocked” positions, and then the user ceased exerting any force on the object 100, then the system of the cam-arm 5c and the cam follower 16 causes the rotary latch 5 to return to the “locked” position;
d. if the user desired to unlock an object 100 from the locking device and if, after the unlocking command was issued by the controller the user pulled the object 100 so that the rotary latch 5 moved beyond the mid-way position between the “locked” and the “unlocked” positions, and then the user ceased exerting any force on the object 100, then the system of the cam-arm 5c and the cam follower 16 causes the rotary latch 5 to continue its rotation until it reaches the “unlocked” position;

2. The system formed by the cam-arm 5c and the cam follower 16 ensures a correct placement of the rotary latch 5 at the extremity of that respective end position, which in turn ensures a firm action of the cam-arm 5c upon the limit switch 12 or 19 corresponding to that end position;

3. The system formed by the cam-arm 5c and the cam follower 16 transmits a firm mechanical feed-back to the user during the operation upon the object body 100, so that the user feels undoubtedly when the locking device gets in one of the two firm end positions, either “locked” or “unlocked”, but also can the user perceive any unstable position of the mechanism if the object was lead only up to an intermediary position between the two firm end positions.

The external diameter of the traction spring 11 should be smaller than the distance between the horizontal faces of the base plate 2 and the top plate 3 so that it can move freely, without friction between those two cases and between the two levers 8 and 9. Also, the length of the spring 11 in free state is chosen to be less than the minimum distance created between the hooks 8b and 9d of the levers 8 and 9 at any moment during the operation of the locking device, so that the spring 11 creates a certain pulling force between the two levers 8 and 9, which ensures keeping the free ends 8c and 9c of the two levers 8 and 9 permanently pulled towards the anti-locking shoulder 5b and, respectively, towards the anti-unlocking shoulder 5d of the rotary latch 5.

If an electrical power failure or a malfunction of the actuator 13 arises during the interval when this is commanded in the sense corresponding to the locking device being in the “unsecured in the unlocked position” state, the rotor 14 must be able to automatically return to its idle median position, with its longitudinal axis as close as possible to horizontal direction. In order to accomplish that, the traction spring 11 mounted between the hooks 8b and 9b of the levers 8 and 9 is dimensioned so that at its maximum elongation related to the “unsecured in the locked position” state of the locking device, the spring 11 would ensure an elastic tension which is at least 50% greater than the force that is necessary to produce a torque which can overcome the resisting torque of rotary shaft of the actuator 13 when this latter is not energized. Similarly, the same characteristic of the spring 11 applies in the case of retiring the rotor 14 from the position corresponding to the “secured in the locked position” state, if the respective power outage or actuator malfunction arises while the locking device is in that state. Thus, the locking device is permanently protected against any accidental remaining in any unblocked state, either “unsecured in the unlocked position” or “unsecured in the locked position”.

If an electrical power outage or a malfunction of the actuator 13 arises during the interval when this is in its idle position, with the rotor 14 placed in horizontal position at mid distance between the levers 8 and 9, that is, when the locking device is in either of the states “secured in the unlocked position” or “secured in the locked position”, it is not possible to modify this position by means of normal use operations. In the particular case of the locking device being in the “secured in the locked position” state with an object 100 having its locking ring 101 locked in the locking device, it is necessary that the locking device provides an administrative means to free the locked object 100 in order to get access to the locking device for further service operations. In this respect, the top plate 3 has a special cut 3b, as shown in FIG. 26, through which an authorized technician can insert a small L-shaped tool inside the locking device and by turning it a small fraction of rotation in trigonometric sense, the respective tool pushes on the end 9c of the anti-unlocking lever 9 so that the free end 9c gets out from the internal side of the anti-unlocking shoulder 5d of the rotary latch 5, which actually represents a manual change of the locking device from the “secured in the locked position” state into the “unsecured in the locked position” state and, keeping by one hand the special L-shaped tool pressed on the free end 9c, the technician can pull with the other hand on the locked object 100 to take it out from the locking device.

As suggested in FIG. 10-17, the parts rotary latch 5, anti-locking lever 8, anti-unlocking lever 9, cam follower 16 and main holder 10 all have a planar geometry and equal thicknesses. This thickness will be designed according to the end use of each locking device application, so to ensure a sufficient mechanical strength during its operation. These five enumerated parts can be realized all from the same raw metal sheet through cutting on machines that can execute complex and precise shape cuttings, such as a laser or plasma cutting machine. In order to be assembled with other parts in the assembly of the locking device and in order to ensure a smooth operation, these five mentioned parts present a few special characteristics, as follows:
the rotary latch 5 has a recess 5a that can receive the locking ring 101 of the object 100 to be locked, an anti-locking shoulder 5b provided for the “secured in the unlocked position” state, a cam-arm 5c and an anti-unlocking shoulder 5d provided for the “secured in the locked position” state, as shown in FIGS. 10 and 11;
the anti-locking lever 8 and the anti-unlocking lever 9 have one of their ends, 8a and respectively 9a shaped as a circular protusion each, as depicted in FIGS. 12 and 13, so that each of the two mentioned circular protrusion 8a and 9a forms a rotation joint in conjunction with a circular cut 10a, respectively 10b, of the main holder 10, and also each lever 8 and 9 has one hook, 8b and respectively 9b, provided to hold the traction spring 11;
the cam follower 16 has a tip 16a that produces the maximum tension on the cam-arm 5c during the rotation of the rotary latch 5 and also has two lateral claws, 16b and 16c, as shown in FIGS. 14 and 15, aimed at limiting the stroke of the cam follower 16 and at keeping it in the two rectangular holes of the main holder 10 shaped on the lateral sides of the guiding rod 10e;
the main holder 10, as shown in FIGS. 16 and 17, has two circular cuts 10a and 10b that together with the circular protrusions 8a and 9a of the levers 8 and 9 compound two rotation joints, and also has a first special pocket 10c and a second special pocket 10f that fit the two limit switches 12 and 19 and also to allow the passing of the electrical wires coming from those two switches 12 and 19 outside the locking device body to the electronic controller; the main holder 10 also has two pins 10d and 10g aimed at securing one side of the limit switches 12 and 19 in the related special pockets 10c and, respectively, 10f and also aimed at separating the unused electrical pins of the two switches 12 and 19 from the remainder of the pins and also has a stopper wall 10h that limits the rotation of the rotary latch 5 when it moves to the “locked” position.

During the operation of the locking device, the eccentric rotor 14 is tensed by mechanical forces that are considerably lower than the forces that act upon the other moving parts of the mechanism and thus it can be made with a thickness lower than that of the main holder 10 and of the levers 8 and 9, and it can also be made of other materials than steel, for instance another metal or even plastic.

As depicted in FIG. 18, the geometry of the mechanical chain compound from the rotary latch 5—anti-locking lever 8—main holder 10 is designed such that there are small mechanical gaps in the subassembly of these parts when the locking device is in the “secured in the unlocked position” state, as follows:
a first mechanical gap, j1, of about 0.3 mm, is provided by design between the anti-locking shoulder 5b and the free end 8c of the anti-locking lever 8;
a second mechanical gap, j2, of about 0.5 mm, is provided by design between the circular protrusion 8a of the anti-locking lever 8 and the circular cut 10a of the main holder 10.

This characteristic of the geometry and relative placement of the parts rotary latch 5, anti-locking lever 8 and main holder 10 has as a result the fact that any attempt from outside to push the rotary latch 5 inwards when the locking device is in the “secured in the unlocked position” state, that is, in a state that has not been previously authorized for locking, shall cause a very short rotation of only 4°-5°, of the rotary latch 5 in counter-trigonometric sense, as much as it takes to eliminate the two mechanical gaps j1 and j2. This short rotation of the rotary latch 5 produces a movement of the cam-arm 5c in the same sense, which movement is big enough to cause the opening of the limit switch 12, which is interpreted by the electronic controller of the locking device as an unauthorized attempt to take the locking device out of the “secured in the unlocked position” state. When the external force that has provoked this short displacement of the rotary latch 5 ceases, the cam follower 16 pushes the cam-arm 5c backwards and thus the rotary latch 5 is rotated back until it reaches its idle position corresponding to the “secured in the unlocked position” state and the limit switch 12 is closed again under the action of the left side of the cam-arm 5c. An eventual alternation of the closed/open signals sent by the limit switch 12 to the controller during a given interval of time can be interpreted by the software application of the system in which the locking device is installed as an alert of non-conforming locking attempt.

Similarly, the geometry of the mechanical chain compound from the rotary latch 5—anti-unlocking lever 9—main holder 10 is designed such that there are small mechanical gaps in the subassembly of these parts when the locking device is in the “secured in the locked position” state, as follows:
a first mechanical gap, of about 0.3 mm, is provided by design between the anti-unlocking shoulder 5d and the free end 9c of the anti-unlocking lever 9;
a second mechanical gap, of about 0.5 mm, is provided by design between the circular protrusion 9a of the anti-unlocking lever 9 and the circular cut 10a of the main holder 10.

This characteristic of the geometry and relative placement of the parts rotary latch 5, anti-unlocking lever 9 and main holder 10 has as a result the fact that any attempt from outside to pull the locked object 100 outwards when the locking device is in the “secured in the locked position” state, that is, in a state that has not been previously authorized for unlocking, shall cause a very short rotation of only 4°-5°, of the rotary latch 5 in trigonometric sense, as much as it takes to eliminate the latter two mechanical gaps. This short rotation of the rotary latch 5 produces a movement of the cam-arm 5c in the same sense, which movement is big enough to cause the opening of the limit switch 19, which is interpreted by the electronic controller of the locking device as an unauthorized attempt to take the locking device out of the “secured in the locked position” state. When the external force that has provoked this short displacement of the rotary latch 5 ceases, the cam follower 16 pushes the cam-arm 5c backwards at that respective and position and thus the rotary latch 5 is rotated back until it reaches its idle position corresponding to the “secured in the locked position” state and the limit switch 19 is closed again under the action of the right side of the cam-arm 5c. An eventual alternation of the closed/open signals sent by the limit switch 19 to the controller during a given interval of time can be interpreted by the software application of the system in which the locking device is installed as an alert of non-conforming unlocking attempt.

During the operation of the locking device, the parts rotary latch 5, anti-locking lever 8, anti-unlocking lever 9 and cam follower 16 constitute moving parts in respect to the main holder 10 that is fixed on the locking device housing compound from the base plate 2 and the top plate 3. Since these mentioned parts 5, 8, 9, 16 and 10 that are mounted between the two plates 2 and 3 have equal thicknesses, it means that special measures need to be taken in order to ensure that the moving parts 5, 8, 9 and 16 can move smoothly within the subassembly of the two plates 2 and 3. In order to achieve this goal, two solutions are provided:

1. A thin spacer 20 is placed above the main holder 10, having a thickness of 0.5-1 mm and a similar shape with that of the main holder 10 in respect to the outside outline and dimensions, which further has two round cuts 20a and 20b identical with and perfectly placed above the two circular cuts 10a and 10b of the main holder 10, and further has two cuts 20c and 20d provided for the passing of the electric wires coming from the limit switches 12 and 19. However, unlike the shape of main holder 10, the thin spacer 20 has a plain area 20e above the two compression springs 17 and 18 so that these could not leave their normal positions during service operations.

2. The base plate 2 and the top plate 3 have two lateral walls each, 2b and 2c as shown in FIG. 25, respectively 3c and 3d as shown in FIG. 26, which are positioned so that when the two plates 2 and 3 are assembled together, the lateral walls 2b and 2c lean on the interior side of the horizontal part of the top plate 3 and the lateral walls 3c and 3d of the top plate receive between them the lateral edges of the horizontal part of the base plate 2. In order to avoid an excessive pressure on the internal parts of the locking device, the lateral walls 2b and 2c of the base plate 2 shall have a height equal to or a little greater than the sum of the thicknesses of the main holder 10 and of the thin spacer 20.

The base plate 2 and the top plate 3 have each a cutout 2e, respectively 3e, each of them having an approximate form of the letter “U”, which are provided so that the locking ring 101 of the object 100 can move towards the internal area of the locking device during the locking operation. These cuts 2e and 3e are necessary so that the locking device according to the invention can accommodate locking rings 101 that are taller than the height of the locking device measured between the external faces of the plates 2 and 3. Similarly, the upper lid 21 of the locking device has a cut placed above the cuts 2e and 3e, for the same reason.

The top plate 3 has two more cutouts, 3f and 3g, provided for the passing of the electrical wires coming from the limit switches 12 and 19 towards the electronic controller of the locking device and a specially profiled cutout 3h provided for the placement of the actuator 13.

The operation of assembling the locking device can be made in the order suggested in FIG. 27 and comprises the following steps:

1. The bolt 6 is inserted in the corresponding hole of the base plate 2 so that the flat cap of the bolt 6 remains under the base plate 2 and afterwards the subassembly of these two parts 2 and 6 is laid down on a horizontal surface;

2. The main holder 10 is placed on the base plate 2;

3. The limit switches 12 and 19 are placed inside their related special pockets 10c and 10f in the main holder 10, so that the third electrical pin of each limit switch 12 and 19 is placed in the specially provided separating cuts of the main holder 10;

4. The rotary latch 5 is mounted on the bolt 6 so that the cam-arm 5c is positioned on the upper left side, close to the limit switch 12;

5. The levers 8 and 9 are positioned inside the main holder 10 so that their circular protrusions 8a and 9a fit inside the circular cuts 10a and, respectively 10b of the main holder 10 and so that the hooks 8b and 9b are facing each other and so that the free end 8c of the anti-locking lever 8 and the free end 9c of the anti-unlocking lever 9 lean on the external edges of the shoulders 5b, respectively 5d of the rotary latch 5;

6. The cam follower 16 is placed inside the main holder 10 so that its vertical axis of symmetry coincides with the vertical axis of symmetry of the guiding rod 10e;

7. The traction spring 11 is mounted with its ends on the hooks 8b and 9b of the levers 8 and 9;

8. The compression springs 17 and 18 are placed inside the special holes provided in the main holder 10 so that they tension the cam follower 16 downwards, pushing this latter on the cam-arm 5c that, as result of this force, is kept at the extremity of the “unlocked” position;

9. The thin spacer 20 is placed upon the subassembly formed at the previous step;

10. The top plate 3 is placed on the subassembly such obtained, then the safety ring 7 is mounted in the recess 6a of the bolt 6 and then the four nuts 4 are fastened on the four threaded rods 2a;

11. The eccentric rotor 14 is placed on the “zero” position of the shaft of the actuator 13;

12. The subassembly made of the actuator 13—eccentric rotor 14 is mounted upon the top plate 3 such that the four threaded rods 3a pass through the four fastening holes of the actuator 13 and the eccentric rotor 14 is underneath the body of the actuator 13 and fits inside the locking device with the longitudinal axis of the rotor 14 oriented towards the center of the rotary latch 5, and afterwards the four nuts 15 are fastened on the four threaded rods 3a. At the end of this step, the assembly of the locking device is complete.

13. It is recommended that a lid 21 is mounted on top of the locking device assembly, in order to prevent from any access from outside to the actuator 13 and to the fastening parts. The lid 21 has a hole provided for the passing of the wires from the limit switches 12 and 19 and from the actuator 13.

14. The locking device can be mounted on the chassis of an equipment by fastening with four solid screws that will be passed through four fastening holes provided on at least two lateral sides of the parts base plate 2, top plate 3 and upper lid 21.

According to a second embodiment of the present invention, related to FIG. 28-31, the rotation joint of the rotary latch 5 inside the housing 1 is compound from a circular opening 5e provided in the rotary latch 5 and a circular protuberance 10k elongated from a main holder 10 that is placed inside the locking device. The inner profile of the circular opening 5e is a circular arc that has an angle greater than 180°, so that the rotation joint created by the pair of the circular opening 5e and the circular protuberance 10k is assured by shape against accidental detaching of the rotary latch 5 from the circular protuberance 10k during the operation of the locking device, but the arc angle is less than the sum of the angle of the rod of the circular protuberance 10k and the angle necessary for a complete stroke of the rotary latch 5 between the “unlocked” and the “locked” positions.

Thus, in this second embodiment of the present invention, the rotation joint of the rotary latch 5 is constituted by a shaped subassembly, which has the advantage that no fastening parts are needed for this element, as was the case in the first embodiment of the invention where the rotation joint comprises the cylindrical bolt 6 and the safety ring 7.

Another difference of the second embodiment compared to the first embodiment of the invention is that the parts housing 1, base plate 2, top plate 3, rotary latch 5, main holder 10, thin spacer 20 and upper lid 21 have shapes and dimensions that are slightly different than those in the first embodiment, but this is only for the aim of accommodating these basically same parts for a different shape and movement of the rotary latch 5 inside the assembly of the locking device. The other components of the assembly, that is, the four nuts 4, the anti-locking lever 8, the anti-unlocking lever 9, the traction spring 11, the limit switches 12 and 19, the actuator 13, the rotor 14, the nuts 15, the cam follower 16 and the springs 17 and 18 have the same shape, dimensions and functional roles as those characteristic to the first embodiment of the invention.

1. A locking device comprising a housing (1) compound from a base plate (2) and a top plate (3), a rotary latch (5) that can rotate between an “unlocked” position and a “locked” position and an actuator (13) controlled by an electronic controller, characterized in that it further comprises an anti-locking lever (8) which can rotate within the locking device and which has a free end (8c) that can be accommodated into an anti-locking shoulder (5b) of said rotary latch (5) for putting the locking device into a “secured in the unlocked position” state, and it further comprises an anti-unlocking lever (9) which can rotate within the locking device and which has a free end (9c) that can be accommodated into an anti-unlocking shoulder (5d) of said rotary latch (5) for putting the locking device into a “secured in the locked position” state, wherein said anti-locking lever (8) and said anti-unlocking lever (9) are connected to each other by a spring (11) which provides the pulling and holding of said levers (8, 9) to one another so that, at any moment, only the free end (8c or 9c) of only one of said levers (8 or 9) is disposed in the corresponding shoulder (5b or 5d) of the rotary latch (5) and the free end (9c or 8c) of the other lever (9 or 8) is disposed outside said other shoulder (5d or 5b) of the rotary latch (5), these positions thus ensuring that the locking device cannot be unlocked or locked without a prior action exerted by the actuator (13) or without a manual administrative intervention on the respective lever (8 or 9) that determines the respective “secured in the unlocked position” state or, respectively, “secured in the locked position” state.

2. A locking device according to claim 1, characterized in that it further comprises a cam follower (16) which biases the rotary latch (5) towards one of the “locked” position and “unlocked” position, and the rotary latch (5) has a cam-arm (5c) which during the stroke of the rotary latch (5) from the “unlocked” position to the “locked” position or vice versa pushes said cam follower (16) so that the reaction force between said cam-arm (5c) and said cam follower (16) increases from a minimum value corresponding to the extremity positions “unlocked” and “locked” to a maximum value at the half stroke of said rotary latch (5) between the two positions “unlocked” and “locked” where the end of said cam-arm (5c) is in contact with a tip (16a) of said cam follower (16) thereby causing the rotary latch (5) to rotate either towards the extremity of the “locked” position or towards the extremity of the “unlocked” position, namely that one towards which is aimed the resultant force of the force exerted by the cam follower (16) upon the rotary latch (5) and of the force exerted from outside by an object (100) that is to be locked or unlocked, which, as a first effect, avoids the rotary latch (5) remaining in an intermediary, unsure position anywhere between the “unlocked” position and the “locked” position when the external force exerted by said object (100) ceases and as a second effect, maintains the rotary latch (5) at the extremity of the respective “unlocked” position or “locked” position, and it further comprises a switch (12) provided to confirm the “unlocked” position, which is closed by the action of said cam-arm (5c) when the rotary latch (5) is in the “unlocked” position, and it further comprises a switch (19) provided to confirm the “locked” position, which is closed by the action of said cam-arm (5c) when the rotary latch (5) is in the “locked” position.

3. A locking device according to claim 1, characterized in that the anti-locking lever (8) and the anti-unlocking lever (9) each have a hook (8b, 9b) which are disposed one facing another and which hold the two ends of said spring (11) that is located in the space bounded by the two locking levers (8, 9), said base plate (2) and said top plate (3).

4. A locking device according to claim 1, characterized in that the actuator (13) consists of a rotary motor installed above and perpendicular to said top plate (3) of the locking device and which has an eccentric rotor (14) mounted on the end of the rotation shaft of said rotary motor, and this actuator subassembly is disposed with said eccentric rotor (14) downwardly through a special cut (3h) of said top plate (3) within said housing (1) in the space between said anti-locking lever (8) and anti-unlocking lever (9).

5. A locking device according to claim 4, characterized in that in order to pass from the “secured in the unlocked position” state in the “unsecured in the unlocked position” state for allowing the locking of said object (100), the actuator (13) is commanded by the electronic control device to effect a fraction of a rotation and thus angularly engages the eccentric rotor (14) which in turn pushes the anti-locking lever (8) to a position where its said free end (8c) passes beyond the tip of said anti-locking shoulder (5b) of the rotary latch (5).

6. A locking device according to claim 4, characterized in that in order to pass from the “secured in the locked position” state in the “unsecured in the locked position” state for allowing the unlocking of said object (100), said actuator (13) is commanded by the electronic control device to effect a fraction of a rotation and thus angularly engages said eccentric rotor (14) which in turn pushes the anti-unlocking lever (9) to a position where its said free end (9c) passes beyond the tip of said anti-unlocking shoulder (5d) of the rotary latch (5).

7. A locking device according to claim 4, characterized in that the spring (11) mounted between the anti-locking lever (8) and the anti-unlocking lever (9) is designed so that in any position thereof it exerts a force that is great enough to pull back said free end (8c or 9c) of the corresponding lever (8 or 9) to its position corresponding to the “secured in the unlocked position” state or, respectively, “secured in the locked position” state, either in the case of the eccentric rotor (14) ceasing to push on the respective lever (8 or 9) or in the case of a power failure of the actuator (13) while the eccentric rotor (14) remains in a position corresponding to the “unsecured in the unlocked position” state or, respectively, in the “unsecured in the locked position” state, so that in case of power failure the force exerted by the spring (11) overcomes the resistant torque of the rotary shaft of the actuator (13) when this latter is not energized.

8. A locking device according to claim 1, characterized in that said anti-locking shoulder (5b) and said anti-unlocking shoulder (5d) are positioned on the outer edge of said rotary latch (5) at an angle from one another designed so that when said rotary latch (5) completes its stroke from the “unlocked” position to the “locked” position, said free end (9c) of said anti-unlocking lever (9) automatically enters said anti-unlocking shoulder (5d) under the effect of the force exerted by said spring (11) on said anti-unlocking lever (9), which causes the locking device to pass into the state “secured in the locked position”, and when said rotary latch (5) completes its stroke back from the “locked” position to the “unlocked” position, said free end (8c) the anti-locking lever (8) automatically enters the anti-locking shoulder (5b) under the effect of the force exerted by said spring (11) on said anti-locking lever (8), which causes the locking device to pass into the “secured in the unlocked position” state.

9. A locking device according to claim 2, characterized in that it further comprises a main holder (10) disposed between said base plate (2) and said top plate (3) of said housing (1), which has a shape with an outer profile which tracks the inner edges of said housing (1) except the movement zone of a receiving recess (5a) of said rotary latch (5) and has an inner profile with cuts specifically designed to assure the mounting and holding inside its body with no need of any fasteners, of said anti-locking lever (8), said anti-unlocking lever (9), said cam follower (16), said switch (12) provided to confirm the “unlocked” position and said switch (19) provided to confirm the “locked” position.

10. A locking device according to claim 9, characterized in that the rotation joint of said rotary latch (5) in horizontal plane within said housing (1) is constituted by the conjugation of a circular protuberance (10k) disposed at the end of an leg profiled within said main holder (10) with a circular opening (5e) centered in the center of rotation of said rotary latch (5), such that a small mechanical gap is provided between said circular protuberance (10k) and said circular opening (5e) and so that the center angle of said circular opening (5e) is smaller than 180° in order to retain by form said rotary latch (5) permanently conjugated with said circular protuberance (10k) during operation of the locking device and the same center angle of said circular opening (5e) is big enough to allow complete angular strokes of said rotary latch (5) between the “unlocked” position and the “locked” positions.

11. A locking device according to claim 9 or 10, characterized in that it further comprises two springs (17, 18) provided for pushing said cam follower (16), which are arranged symmetrically with respect to the axis of symmetry of said cam follower (16) and as close as possible to the lateral edges of said cam follower (16) so that to provide a sliding movement thereof with as small as possible deviations from linear direction under the effect of an oblique action of said cam-arm (5c) of said rotary latch (5) when it moves between the “unlocked” position and the “locked” position, said springs (17, 18) being arranged inside two cuts at the inner side of the profile of said main holder (10) and being disposed symmetrical to each other with respect to the symmetry axis of a guiding rod (10e) of said main holder (10), wherein said guiding rod (10e) has two lateral tabs that conjugate with two lateral claws (16b, 16c) of said cam follower (16) so that to maintain it within its normal working space.

12. A locking device according to claim 11, characterized in that said rotary latch (5), said main holder (10), said anti-locking lever (8), said anti-unlocking lever (9) and said cam follower (16) are all of a flat geometry, which allows them to be made from a metal sheet only by cutting operations.

13. A locking device according to claim 11, characterized in that in order to eliminate the need for using other fasteners for the realization of the angular rotation joints of both said anti-locking lever (8) and said anti-unlocking lever (9) within the locking device as well as to provide a simpler form of said base plate (2) and said top plate (3) by eliminating the need for holes that would otherwise materialize said two rotation joints, said anti-locking lever (8) has at one end an circular protrusion (8a) and said anti-unlocking lever (9) has at one end an circular protrusion (9a) which forms, each of them, the inner part of a rotation joint formed in conjunction with a first circular cut (10a) and, respectively, with a second circular cut (10b) of said main holder (10), wherein said first and second circular cuts (10a, 10b) consist each from a circular sector greater than 180° to assure the retention of said circular protrusions (8a, 9a) of said anti-locking lever (8) and of said anti-unlocking lever (9) inside respective rotation joints during operation of the unlocking device.

14. A locking device according to claim 11, characterized in that said main holder (10) further has a first special pocket (10c) specially shaped for a precise fitting of the body of said switch (12) provided to confirm the “unlocked” position and further has a second special pocket (10f) specially shaped for a precise fitting of the body of said switch (19) provided to confirm the “locked” position, so as to provide a fixed positioning arrangement of said switches (12, 19) in respect to said main holder (10) without the need for other fasteners, and so that the swinging blades of said switches (12, 19) remain out from these cuts in order to be possibly actuated by said cam-arm (5c).

15. A locking device according to claim 14, characterized in that said main holder (10) further comprises in its inner profile a first pin (10d) which constitutes a point of support for positioning the switch (12) provided to confirm the “unlocked” position in said first special pocket (10c) for mounting it inside the main holder (10), and which is intended to separate a third unused electronic pin of the switch (12) from the other two pins of said switch (12), so that this electronic pin does not touch any part of said main holder (10), nor of the base plate (2), nor of the top plate (3), and further comprises a second pin (10g) which constitutes a first point of support for positioning the switch (19) provided to confirm the “locked” position in said second special pocket (10f) for mounting it inside the main holder (10), and which is intended to separate a third unused electronic pin of the switch (19) from the other two pins of said latter switch (19), so that this electronic pin does not touch any part of said main holder (10), nor of the base plate (2), nor of the top plate (3).

16. A locking device according to claim 14, characterized in that said main holder (10) further comprises in its inner profile a first small shoulder (10i) inside said first special pocket (10c) for supporting the switch (12) provided to confirm the “unlocked” position, arranged so that the first small shoulder (10i) is located between the body of the switch (12) and its swinging blade, and having a thickness sufficiently small so as not to impede the closure of the swinging blade during the normal operation of the switch (12), and the main holder (10) further comprises in its inner profile a second small shoulder (10j) inside said second special pocket (10f), arranged so that the second small shoulder (10j) is located between the body of the latter switch (19) and its swinging blade, and having a thickness sufficiently small so as not to impede the closure of said latter swinging blade during the normal operation of the latter switch (19).

17. A locking device according to claim 9 or 10, characterized in that the main holder (10) further comprises a stopper wall (10h) disposed at the end of the stroke of the corresponding area of the rotary latch (5) to the “locked” position, so limiting the stroke of said rotary latch (5) in this position.

18. A locking device according to claim 9 or 10, characterized in that the length of the anti-locking lever (8) and the diameter of said circular protrusion (8a) of the anti-locking lever (8) are dimensioned such that, when the locking device is in the “secured in the unlocked position” state with no action force from outside, a mechanical gap (j1) is formed between said anti-locking shoulder (5b) of the rotary latch (5) and said free end (8c) of the anti-locking lever (8) and another mechanical gap (j2) is formed between the outer part of said circular protrusion (8a) of the anti-locking lever (8) and the inner part of said corresponding circular cut (10a) of the main holder (10), these two mechanical gaps (j1, j2) being specially provided so that an eventual attempt to push from outside on the rotary latch (5) towards the “locked” position when the locking device is in the “secured in the unlocked position” state results in a very small angular movement of the rotary latch (5) up to a point where said two mechanical gaps (j1, j2) are suppressed and thus causing a short rotation of said cam-arm (5c) in the same sense as the short angular movement of the rotary latch (5), which will have as a first effect the opening of the switch (12) provided to confirm the “unlocked” position of the rotary latch (5), event which will be alerted to the locking device controller, and a second effect consisting in increasing the reaction force of said cam follower (16) on said cam-arm (5c) so that said cam-arm (5c) will be pushed back by the cam follower (16) when the external force on the rotary latch (5) ceases and thus said rotary latch (5) will return at the end of the “unlocked” position where said cam-arm (5c) will re-close the switch (12).

19. A locking device according to claim 9 or 10, characterized in that the length of the anti-unlocking lever (9) and the diameter of said circular protrusion (9a) of the anti-unlocking lever (9) are dimensioned such that, when the locking device is in the “secured in the locked position” state with no action force from outside, a mechanical gap is formed between said anti-unlocking shoulder (5d) of the rotary latch (5) and said free end (9c) of the anti-unlocking lever (9) and another mechanical gap is formed between the outer part of said circular protrusion (9a) of the anti-unlocking lever (9) and the inner part of said corresponding circular cut (10b) of the main holder (10), these two mechanical gaps being specially provided so that an eventual attempt to pull from outside on the rotary latch (5) towards the “unlocked” position when the locking device is in the “secured in the locked position” state results in a very small angular movement of the rotary latch (5) up to a point where said two latter mechanical gaps are suppressed and thus causing a short rotation of said cam-arm (5c) in the same sense as the short angular movement of the rotary latch (5), which will have as a first effect the opening of the switch (19) provided to confirm the “locked” position of the rotary latch (5), event which will be alerted to the locking device controller, and a second effect consisting in increasing the reaction force of the cam follower (16) on said cam-arm (5c) so that said cam-arm (5c) will be pushed back by the respective cam follower (16) when the external force on the rotary latch (5) ceases and thus the rotary latch (5) will return at the end of the “locked” position where said cam-arm (5c) will re-close the latter switch (19).
